(19) United States
(12) Patent Application Publication
(10) Pub. No.: US 2020/0258165 A1
(43) Pub. Date: Aug. 13, 2020

(54) METHOD FOR AUTOMATIC CLASSIFICATION OF BILL, STORAGE MEDIUM, AND MOBILE TERMINAL

(71) Applicant: JRD Communication (Shenzhen) Ltd., Shenzhen City (CN)

(72) Inventor: Wenqiang Song, Shenzhen City (CN)

(21) Appl. No.: 16/641,102

(22) PCT Filed: Aug. 14, 2018
(86) PCT No.: PCT/CN2018/100514

§ 371 Date: Feb. 21, 2020

(30) Foreign Application Priority Data
Aug. 21, 2017 (CN) 201710720293.4

(51) Int. Cl. G06Q 40/00; G06Q 20/32; G06F 16/23

(52) U.S. Cl. CPC G06Q 40/12; G06Q 20/3221; G01S 19/42; G06Q 20/3267; G06F 16/2379; G06Q 20/3223

(57) ABSTRACT

Disclosed in the present invention are a method for automatic classification of a bill, a storage medium, and a mobile terminal. The method comprises the steps of: obtaining, when detecting that a mobile terminal is performing mobile payment, current mobile payment information, a current geographical location of the mobile terminal, and store information at the current geographical location; and associating the current mobile payment information with the current store information, and then storing the information to implement automatic classification of a bill.

### CROSS REFERENCE

This application claims the priority of Chinese Patent Application No. 201710720293.4, entitled “METHOD FOR AUTOMATIC CLASSIFICATION OF BILL, STORAGE MEDIUM, AND MOBILE TERMINAL”, filed on Aug. 21, 2017, the disclosure of which is incorporated herein by reference in its entirety.

### FIELD OF THE INVENTION

The present disclosure relates to the field of bill recording, more particularly, to a method for automatically classifying bills, a storage medium and a mobile terminal.

### BACKGROUND

With the rapid development of network technology, mobile payment currently has become the most popular payment method. Mobile payment has brought about huge changes to the lifestyle of human beings. Nowadays, people only need to carry a mobile phone to deal with their everyday life. Expenses for taxis, hotel booking, meals, and movies, etc., can all be solved by mobile payments.

Although the mobile payment methods in the related art will automatically generate recorded bills in chronological order after payment is completed, the generated recorded bills can not be automatically classified based on the store information of the current geographical location. This brings great inconveniences to some users who want to know their consumption situations at the current store.

Therefore, there is a need to provide a method for automatically classifying bills, a storage medium and a mobile terminal to improve the related art.

### SUMMARY

### Technical Problem

The embodiment according to the present disclosure provides a method for automatically classifying bills, a storage medium and a mobile terminal. When a recorded bill is generated by the mobile payment method, it can be automatically classified based on the store information of the geographical location to help a user know the consumption situation at each store so as to improve user experience.

### Technical Solution

One aspect of the embodiment of the present disclosure provides a method for automatically classifying bills. The method comprises the following steps:

obtaining current mobile payment information, a current geographical location of a mobile terminal, and store information of the current geographical location when it is detected that the mobile terminal is performing mobile payment; and

associating the current mobile payment information and the current store information with each other and storing them to achieve automatic classification of bills.

Furthermore, after the step of obtaining the current mobile payment information, the current geographical location of the mobile terminal, and the store information of the current geographical location when it is detected that the mobile terminal is performing the mobile payment, the method further comprises:

displaying a historical billing record related to the store information when the store information of the current geographic location is obtained.

Furthermore, the step of obtaining the current mobile payment information, the current geographical location of the mobile terminal, and the store information of the current geographical location when it is detected that the mobile terminal is performing mobile payment comprises:

obtaining the current geographic location of the mobile terminal and the store information of the current geographic location through a GPRS positioning system when it is detected that the mobile terminal is performing the mobile payment.

Furthermore, the mobile payment comprises WeChat pay, Alipay, Apple Pay, or bank card payment associated with the mobile terminal.

Furthermore, the store information comprises a store name, a store geographical location, and a type of product sold by the store.

Furthermore, the current mobile payment information comprises a payment time, a name of a paid product, a size of the paid product and a payment fee.

Furthermore, the step of associating the current mobile payment information and the current store information with each other and storing them to achieve automatic classification of bills comprises:

arranging and storing the current mobile payment information and the current store information according to a predetermined order to achieve automatic classification of bills.

Furthermore, the mobile terminal is a smart phone.

Another aspect of the embodiment of the present disclosure provides a storage medium storing a plurality of instructions adapted to be loaded and executed by a processor to perform the following operations:

obtaining current mobile payment information, a current geographical location of a mobile terminal, and store information of the current geographical location when it is detected that the mobile terminal is performing mobile payment; and

associating the current mobile payment information and the current store information with each other and storing them to achieve automatic classification of bills.

Furthermore, after the operation of obtaining the current mobile payment information, the current geographical location of the mobile terminal, and the store information of the current geographical location when it is detected that the mobile terminal is performing the mobile payment, the method further comprises:

displaying a historical billing record related to the store information when the store information of the current geographic location is obtained.

Furthermore, the operation of obtaining the current mobile payment information, the current geographical location of the mobile terminal, and the store information of the current geographical location when it is detected that the mobile terminal is performing mobile payment comprises:

obtaining the current geographic location of the mobile terminal and the store information of the current geographic location through a GPRS positioning system when it is detected that the mobile terminal is performing the mobile payment.

Furthermore, the mobile payment comprises WeChat pay, Alipay, Apple Pay, or bank card payment associated with the mobile terminal.

Still another aspect of the embodiment of the present disclosure provides a mobile terminal. The mobile terminal comprises a processor adapted to implement each instruction, and a memory adapted to store a plurality of instructions, the instructions being adapted to be loaded and executed by the processor to perform the following operation:

obtaining current mobile payment information, a current geographical location of a mobile terminal, and store information of the current geographical location when it is detected that the mobile terminal is performing mobile payment; and

associating the current mobile payment information and the current store information with each other and displaying them on a display interface of the mobile terminal, and performing storing according to display content on the display interface to achieve automatic classification of bills, wherein the display interface is configured to display and edit the display content

Furthermore, after the operation that the processor is executed to obtain the current mobile payment information, the current geographical location of the mobile terminal, and the store information of the current geographical location when it is detected that the mobile terminal is performing the mobile payment, the processor further performs:

displaying a historical billing record related to the store information when the store information of the current geographic location is obtained.

Furthermore, the historical bill record is data arranged in sequence in chronological order according to a purchase time.

Furthermore, the operation that the processor is executed to obtain the current mobile payment information, the current geographical location of the mobile terminal, and the store information of the current geographical location when it is detected that the mobile terminal is performing mobile payment comprises:

obtaining the current geographic location of the mobile terminal and the store information of the current geographic location through a GPRS positioning system when it is detected that the mobile terminal is performing the mobile payment.

Furthermore, the mobile payment comprises WeChat pay, Alipay, Apple Pay, or bank card payment associated with the mobile terminal.

Furthermore, the store information comprises a store name, a store geographical location, and a type of product sold by the store.

Furthermore, the current mobile payment information comprises a payment time, a name of a paid product, a size of the paid product and a payment fee.

Furthermore, the operation that the processor is executed to associate the current mobile payment information and the current store information with each other and display them on the display interface of the mobile terminal, and perform storing according to the display content on the display interface to achieve automatic classification of bills comprises:

arranging the current mobile payment information and the current store information according to the predetermined order and displaying them on the display interface of the mobile terminal, and performing storing according to the display content on the display interface to achieve automatic classification of bills.

### Advantageous Effect

The present disclosure provides a method for automatically classifying bills, a storage medium and a mobile terminal. The method comprises: the mobile terminal being detected in real time, obtaining current mobile payment information, a current geographical location of a mobile terminal, and store information of the current geographical location when it is detected that the mobile terminal is performing mobile payment; and associating the current mobile payment information and the current store information with each other and storing them to achieve automatic classification of bills. Through the present disclosure, a user can directly associate the user's own expenses with the store information of the current geographical location of the user and store them to achieve the objective of automatic classification of bills, which facilitates the user to clearly know his/her consumption situation at a specific store.

### BRIEF DESCRIPTION OF THE DRAWINGS

FIG. 1 is a flowchart of a method for automatically classifying bills according to a preferred embodiment of the present disclosure.

FIG. 2 is a block diagram of a structure of a mobile terminal according to a preferred embodiment of the present disclosure.

FIG. 3 is a block diagram of a detailed structure of a mobile terminal according to one embodiment of the present disclosure.

### DESCRIPTION OF THE EMBODIMENTS

The present disclosure provides a method for automatically classifying bills, a storage medium and a mobile terminal. In order to make the objectives, technical solutions, and effects of the present disclosure more clear and specific, a detailed description for the present disclosure is provided as follows. It should be understood that the embodiments described herein are only used to illustrate the present disclosure and are not intended to limit the present disclosure.

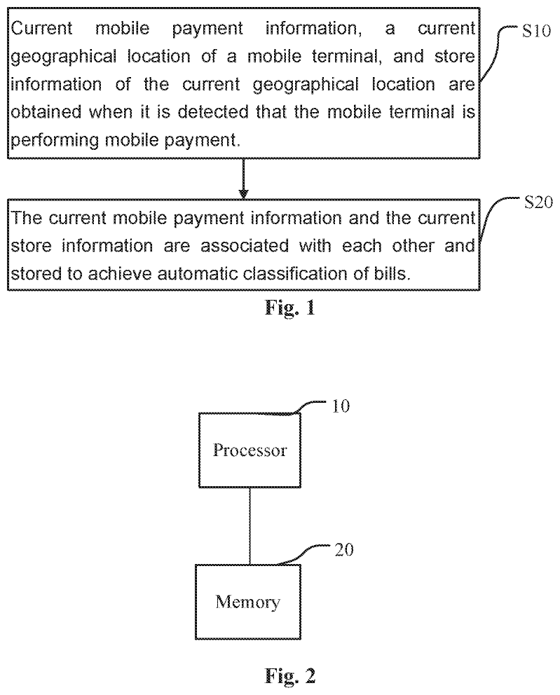

A description is provided with reference to FIG. 1. FIG. 1 is a flowchart of a method for automatically classifying bills according to a preferred embodiment of the present disclosure. As shown in the figure, the method comprises the following steps:

Step S10: Current mobile payment information, a current geographical location of a mobile terminal, and store information of the current geographical location are obtained when it is detected that the mobile terminal is performing mobile payment.

Step S20: The current mobile payment information and the current store information are associated with each other and stored to achieve automatic classification of bills.

In greater detail, the mobile payment method in the related art will automatically generate recorded bills in chronological order after payment is completed. However, the generated recorded bills can not be automatically classified based on the store information of the current geographical location. This brings great inconveniences to some users who want to know their consumption situations at the current store.

In order to resolve the above problem, the mobile terminal is detected in real time according to the present disclosure. When it is detected that the mobile terminal is performing mobile payment, the current mobile payment information, the current geographical location of the mobile terminal, and the store information of the current geographical location are obtained, and the current mobile payment information and the current store information are associated with each other and stored to achieve automatic classification of bills. Through the present disclosure, a user can directly associate the user's own expenses with the store information of the current geographical location of the user and store them to achieve the objective of automatic classification of bills, which facilitates the user to clearly know his/her consumption situation at a specific store.

Step S10 comprises: When it is detected that the mobile terminal is performing the mobile payment, the current geographic location of the mobile terminal and the store information of the current geographic location are obtained through a GPRS positioning system.

The GPRS positioning system of the mobile terminal is turned on in advance, and the mobile terminal is monitored in real time. When it is detected that the mobile terminal is performing the mobile payment, the GPRS positioning system is used to obtain the current geographical location of the mobile terminal and the store information of the current geographical location. At the same time, the current mobile payment information is obtained.

The current geographical location of the mobile terminal refers to the longitude and latitude of the current location of the mobile terminal, that is, the current location of the user. In greater detail, the GPRS positioning system is used to obtain the store information of the current geographical location. The store information specifically comprises a store name, a store geographical location, and a type of product sold by the store.

The mobile payment comprises WeChat pay, Alipay, Apple Pay, or bank card payment associated with the mobile terminal. All of the above payment methods need to confirm payment through the mobile terminal, and the mobile payment information is fed to the mobile terminal.

Preferably, the mobile payment information comprises a payment time, a name of a paid product, a size of the paid product, a payment fee, and the like.

In greater detail, in step S20, the current mobile payment information and the current store information are associated with each other and stored to achieve automatic classification of bills. In greater detail, the current mobile payment information and the current store information are arranged and stored according to a predetermined order to achieve automatic classification of bills.

In a preferred embodiment, the predetermined order is:

Store name: Ode to Joy;

Store geographical location: 3030 Nanxin Road, Nanshan District, Shenzhen;

Store product type: Clothing;

Payment time: 2017-8-10;

Payment fee: 1200 RMB;

Paid product name: shirt;

Paid product size: Size L;

Payment method: WeChat pay.

The predetermined order is not limited to the above embodiment. The predetermined order may be automatically adjusted depending on user's needs, and the display content may also be deleted or added depending on user's needs.

In greater detail, the current mobile payment information and the current store information may be associated with each other and displayed on a display interface of the mobile terminal, and storing is performed according to display content on the display interface to achieve automatic classification of bills. The display interface can be configured to display and edit the display content. For example, an editing operation, such as deleting or adding, etc., can be performed on the display content according to a received editing instruction input by the user. In greater detail, the current mobile payment information and the current store information can be arranged according to the predetermined order and displayed on the display interface of the mobile terminal, and storing is performed according to the display content on the display interface to achieve automatic classification of bills.

For example, in another embodiment, the predetermined order is:

Store Name: Wal-Mart;

Store geographical location: 1001 Chunfeng Road, Luohu District, Shenzhen;

Payment method: Alipay;

Payment fee: 3000 RMB;

Paid product name: Red wine.

The current mobile payment information and the current store information are associated with each other and stored through the user-defined predetermined order to achieve automatic classification of bills.

After step S10, the method further comprises: A historical billing record related to the store information is displayed when the store information of the current geographic location is obtained.

Then the user makes a purchase through the mobile payment, the store information of the current geographic location of the mobile terminal is obtained. Then, the historical billing record related to the store information is displayed. In greater detail, the mobile terminal displays a historical billing record of the user at a current store. The historical billing record is data that is the mobile payment information and the store information arranged and stored according to the predetermined order. Preferably, the historical billing record is arranged in sequence in chronological order according to a purchase time.

Based on the above method, the present disclosure further provides a storage medium. The storage medium stores a plurality of instructions. The instructions are adapted to be loaded and executed by a processor to perform any one of the methods for automatically classifying bills.

One person of ordinary skill in the art would understand that all or part of the steps of the various methods of the foregoing embodiments may be performed by a program to instruct relevant hardware. The program may be stored in a computer readable storage medium. The storage medium may comprise a read only memory (ROM), a random access memory (RAM), a magnetic disk, or an optical disc, etc.

In one embodiment, the storage medium stores a plurality of instructions. The instructions are adapted to be loaded and executed by a processor to perform:

obtaining current mobile payment information, a current geographical location of a mobile terminal, and store information of the current geographical location when it is detected that the mobile terminal is performing mobile payment; and

associating the current mobile payment information and the current store information with each other and storing them to achieve automatic classification of bills.

In another embodiment, the storage medium stores a plurality of instructions. The instructions are adapted to be loaded and executed by a processor to perform:

displaying a historical billing record related to the store information when the store information of the current geographic location is obtained.

A description is provided with reference to FIG. 2. FIG. 2 is a block diagram of a structure of a mobile terminal according to a preferred embodiment of the present disclosure. The mobile terminal comprises a processor 10 adapted to implement each instruction, and a memory 20 adapted to store a plurality of instructions. The instructions are adapted to be loaded and executed by the processor 10 to perform any one of the methods for automatically classifying bills.

The processor 10 may be a central processing unit, a microprocessor, or other data processing chip in some embodiments, and is configured to run program codes stored in the memory 20 or process data.

The memory 20 may be an internal memory unit of the device in some embodiments, such as a hard disk or a memory of the device. In some other embodiments, the memory 20 may be a memory external to the device, such as a plug-in hard disk, a smart media card (SMC), a secure digital (SD) card, a flash card and so on, equipped for the device.

The memory 20 may further comprise both the internal storage unit of the device and the memory external to the device. The memory 20 is configured to store application software and various types of data installed in the device. The memory 20 may further be configured to temporarily store data that has been output or is to be output.

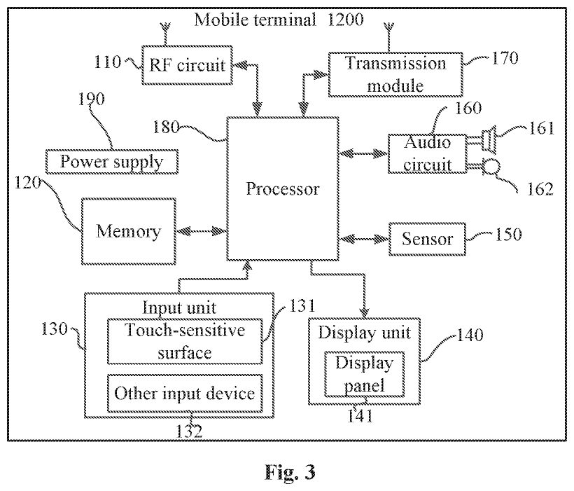

FIG. 3 is a block diagram of a detailed structure of a mobile terminal 1200 according to one embodiment of the present disclosure. The mobile terminal 1200 can be used to perform the method for automatically classifying bills provided by the above embodiment. The mobile terminal 1200 may be a smart phone or a tablet computer.

As shown in FIG. 3, the mobile terminal 1200 may comprise components, such as a radio frequency (RF) circuit 110, a memory 120 including one or more (only one is shown in the figure) computer-readable storage media, an input unit 130, a display unit 140, a sensor 150, an audio circuit 160, a transmission module 170, a processor 180 including one or more (only one is shown in the figure) processing cores, and a power supply 190, etc. Those skilled in the art would understand that the mobile terminal 1200 is not limited to the structure of the mobile terminal 1200 shown in FIG. 3. The mobile terminal 1200 may comprise more or less components than those illustrated in the figure, or some components may be combined, or the mobile terminal 1200 may have different component arrangements.

The RF circuit 110 may be configured to receive and send a signal during an information receiving and sending process or a conversation process. Specifically, after receiving downlink information from a base station, the RF circuit 110 delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, a Global System for Mobile communications (GSM), an Enhanced Data GSM Environment (EDGE), a Wideband Code Division Multiple Access (WCDMA), a Code Division Access (CDMA), a Time Division Multiple Access (TDMA), a Wireless Fidelity (Wi-Fi) such as IEEE 802.11a, IEEE 802.11b, IEEE802.11g and IEEE 802.11n, a Voice over Internet Protocol (VoIP), a Worldwide Interoperability for Microwave Access (Wi-Max), any other protocols for e-mail, instant communication and short message, and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the terminal 1200, and the like. In addition, the memory 120 may include a high speed random access memory, and may also include a non-volatile memory, such as at least one magnetic disk storage device, a flash memory device, or another volatile solid-state storage device. Correspondingly, the memory 120 may further include a memory controller, so that the processor 180 and the input unit 130 access the memory 120.

The input unit 130 may be configured to receive input digit or character information, and generate keyboard, mouse, joystick, optical, or track ball signal input related to the user setting and function control. Specifically, the input unit 130 may include a touch-sensitive surface 131 and other input device 132. The touch-sensitive surface 131 may also be referred to as a touch screen or a touch panel, and may collect a touch operation of a user on or near the touch-sensitive surface (such as an operation of a user on or near the touch-sensitive surface 131 by using any suitable object or attachment, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitance type, an infrared type, and a surface sound wave type. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user ports of the terminal 1200. The graphical user ports may be formed by a graph, a text, an icon, a video, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 5, the touch-sensitive surface 131 and the display panel 141 are used as two separate parts to implement input and output functions, in some embodiments, the touch-sensitive surface 131 and the display panel 141 may be integrated to implement the input and output functions.

The terminal 1200 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1200 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone attitude (such as switching between horizontal and vertical screens, a related game, and attitude calibration of a magnetometer), a related function of vibration identification (such as a pedometer and a knock). Other sensors, such as a gyroscope, a barometer, a hygrometer, a thermometer, and an infrared sensor, which may be configured in the terminal 1200 are not further described herein.

The audio circuit 160, a loudspeaker 161, and a microphone 162 may provide audio interfaces between the user and the terminal 1200. The audio circuit 160 may transmit, to the loudspeaker 161, a received electric signal converted from received audio data. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, so as to provide communication between a peripheral earphone and the terminal 1200.

The terminal 1200 may help, by using the transmission module 170 (e.g. Wi-Fi module), a user to receive and send an e-mail, browse a webpage, and access stream media, and the like, which provides wireless broadband Internet access for the user. Although FIG. 5 shows the transmission module 170, it may be understood that, the wireless communications unit is not a necessary component of the terminal 1200, and can be ignored according to demands without changing the scope of the essence of the present disclosure.

The processor 180 is a control center of the terminal 1200, and connects various parts of the terminal by using various interfaces and lines. By running or executing the software program and/or module stored in the memory 120, and invoking data stored in the memory 120, the processor 180 performs various functions and data processing of the terminal 1200, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that, the foregoing modem may not be integrated into the processor 180.

The terminal 1200 further includes the power supply 190 (such as a battery) for supplying power to the components. Preferably, the power supply may be logically connected to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

The mobile terminal 1200 may further comprise a camera (such as a front camera, a rear camera), a Bluetooth module, and the like, and a description in this regard is not provided. In greater detail, a display unit of the mobile terminal is a touch screen display according to the present embodiment. The mobile terminal further comprises a memory and one or more programs. The one or one or more programs are stored in the memory, and are configured to be executed by one or more processors to perform operations of:

obtaining current mobile payment information, a current geographical location of a mobile terminal, and store information of the current geographical location when it is detected that the mobile terminal is performing mobile payment; and

associating the current mobile payment information and the current store information with each other and displaying them on a display interface of the mobile terminal, and performing storing according to display content on the display interface to achieve automatic classification of bills, wherein the display interface is configured to display and edit the display content

After the operation that the processor 180 is executed to obtain the current mobile payment information, the current geographical location of the mobile terminal, and the store information of the current geographical location when it is detected that the mobile terminal is performing the mobile payment, the processor further performs:

displaying a historical billing record related to the store information when the store information of the current geographic location is obtained.

The historical bill record is data arranged in sequence in chronological order according to a purchase time.

The operation that the processor 180 is executed to obtain the current mobile payment information, the current geographical location of the mobile terminal, and the store information of the current geographical location when it is detected that the mobile terminal is performing mobile payment comprises:

obtaining the current geographic location of the mobile terminal and the store information of the current geographic location through a GPRS positioning system when it is detected that the mobile terminal is performing the mobile payment.

The mobile payment comprises WeChat pay, Alipay, Apple Pay, or bank card payment associated with the mobile terminal.

The store information comprises a store name, a store geographical location, and a type of product sold by the store.

The current mobile payment information comprises a payment time, a name of a paid product, a size of the paid product and a payment fee.

The operation that the processor 180 is executed to associate the current mobile payment information and the current store information with each other and display them on the display interface of the mobile terminal, and perform storing according to the display content on the display interface to achieve automatic classification of bills comprises:

arranging the current mobile payment information and the current store information according to the predetermined order and displaying them on the display interface of the mobile terminal, and performing storing according to the display content on the display interface to achieve automatic classification of bills.

The present disclosure provides a method for automatically classifying bills, a storage medium and a mobile terminal. The method comprises: the mobile terminal being detected in real time, obtaining current mobile payment information, a current geographical location of a mobile terminal, and store information of the current geographical location when it is detected that the mobile terminal is performing mobile payment; and associating the current mobile payment information and the current store information with each other and storing them to achieve automatic classification of bills. Through the present disclosure, a user can directly associate the user's own expenses with the store information of the current geographical location of the user and store them to achieve the objective of automatic classification of bills, which facilitates the user to clearly know his/her consumption situation at a specific store.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A method for automatically classifying bills comprising:
obtaining current mobile payment information, a current geographical location of a mobile terminal, and store information of the current geographical location when it is detected that the mobile terminal is performing mobile payment; and
associating the current mobile payment information and the current store information with each other and storing them to achieve automatic classification of bills.

2. The method as claimed in claim 1, wherein after the step of obtaining the current mobile payment information, the current geographical location of the mobile terminal, and the store information of the current geographical location when it is detected that the mobile terminal is performing the mobile payment, the method further comprises:
displaying a historical billing record related to the store information when the store information of the current geographic location is obtained.

3. The method as claimed in claim 1, wherein the step of obtaining the current mobile payment information, the current geographical location of the mobile terminal, and the store information of the current geographical location when it is detected that the mobile terminal is performing mobile payment comprises:
obtaining the current geographic location of the mobile terminal and the store information of the current geographic location through a GPRS positioning system when it is detected that the mobile terminal is performing the mobile payment.

4. The method as claimed in claim 3, wherein the mobile payment comprises WeChat pay, Alipay, Apple Pay, or bank card payment associated with the mobile terminal.

5. The method as claimed in claim 3, wherein the store information comprises a store name, a store geographical location, and a type of product sold by the store.

6. The method as claimed in claim 3, wherein the current mobile payment information comprises a payment time, a name of a paid product, a size of the paid product and a payment fee.

7. The method as claimed in claim 1, wherein the step of associating the current mobile payment information and the current store information with each other and storing them to achieve automatic classification of bills comprises:
arranging and storing the current mobile payment information and the current store information according to a predetermined order to achieve automatic classification of bills.

8. The method as claimed in claim 1, wherein the mobile terminal is a smart phone.

9. A storage medium storing a plurality of instructions adapted to be loaded and executed by a processor to perform the following operations:
obtaining current mobile payment information, a current geographical location of a mobile terminal, and store information of the current geographical location when it is detected that the mobile terminal is performing mobile payment; and
associating the current mobile payment information and the current store information with each other and storing them to achieve automatic classification of bills.

10. The storage medium as claimed in claim 9, wherein after the operation of obtaining the current mobile payment information, the current geographical location of the mobile terminal, and the store information of the current geographical location when it is detected that the mobile terminal is performing the mobile payment, the method further comprises:
displaying a historical billing record related to the store information when the store information of the current geographic location is obtained.

11. The storage medium as claimed in claim 9, wherein the operation of obtaining the current mobile payment information, the current geographical location of the mobile terminal, and the store information of the current geographical location when it is detected that the mobile terminal is performing mobile payment comprises:
obtaining the current geographic location of the mobile terminal and the store information of the current geographic location through a GPRS positioning system when it is detected that the mobile terminal is performing the mobile payment.

12. The storage medium as claimed in claim 11, wherein the mobile payment comprises WeChat pay, Alipay, Apple Pay, or bank card payment associated with the mobile terminal.

13. A mobile terminal comprising a processor adapted to implement each instruction, and a memory adapted to store a plurality of instructions, the instructions being adapted to be loaded and executed by the processor to perform the following operations:
obtaining current mobile payment information, a current geographical location of a mobile terminal, and store information of the current geographical location when it is detected that the mobile terminal is performing mobile payment; and
associating the current mobile payment information and the current store information with each other and displaying them on a display interface of the mobile terminal, and performing storing according to display content on the display interface to achieve automatic classification of bills, wherein the display interface is configured to display and edit the display content

14. The mobile terminal as claimed in claim 13, wherein after the operation that the processor is executed to obtain the current mobile payment information, the current geographical location of the mobile terminal, and the store information of the current geographical location when it is detected that the mobile terminal is performing the mobile payment, the processor further performs:
displaying a historical billing record related to the store information when the store information of the current geographic location is obtained.

15. The mobile terminal as claimed in claim 14, wherein the historical bill record is data arranged in sequence in chronological order according to a purchase time.

16. The mobile terminal as claimed in claim 13, wherein the operation that the processor is executed to obtain the current mobile payment information, the current geographical location of the mobile terminal, and the store information of the current geographical location when it is detected that the mobile terminal is performing mobile payment comprises:
obtaining the current geographic location of the mobile terminal and the store information of the current geographic location through a GPRS positioning system when it is detected that the mobile terminal is performing the mobile payment.

17. The mobile terminal as claimed in claim 16, wherein the mobile payment comprises WeChat pay, Alipay, Apple Pay, or bank card payment associated with the mobile terminal.

18. The mobile terminal as claimed in claim 16, wherein the store information comprises a store name, a store geographical location, and a type of product sold by the store.

19. The mobile terminal as claimed in claim 16, wherein the current mobile payment information comprises a payment time, a name of a paid product, a size of the paid product and a payment fee.

20. The mobile terminal as claimed in claim 13, wherein the operation that the processor is executed to associate the current mobile payment information and the current store information with each other and display them on the display interface of the mobile terminal, and perform storing according to the display content on the display interface to achieve automatic classification of bills comprises:
arranging the current mobile payment information and the current store information according to the predetermined order and displaying them on the display interface of the mobile terminal, and performing storing according to the display content on the display interface to achieve automatic classification of bills.
